(19) United States
(12) Patent Application Publication
(10) Pub. No.: US 2013/0011725 A1
(43) Pub. Date: Jan. 10, 2013

(54) PACKAGE FOR LARGE FORMAT LITHIUM ION CELLS

(76) Inventors: Henry Meehan, Suffern, NY (US); David Paolazzi, North Arlington, NJ (US)

(21) Appl. No.: 13/636,552

(22) PCT Filed: Mar. 23, 2011
(86) PCT No.: PCT/US11/29507

§ 371 Date: Sep. 21, 2012

Related U.S. Application Data
(63) Continuation of application No. 12/729,790, filed on Mar. 23, 2010, now abandoned.

(51) Int. Cl. H01M 2/06; H01M 2/04; H01M 10/04; H01M 2/30

(52) U.S. Cl. 429/179; 29/623.2

(57) ABSTRACT

A battery cell is disclosed. The battery cell includes a sealed foil pouch having a plurality of openings and a terminal block disposed within the sealed foil pouch. The terminal block has a plurality of terminals extending outwardly therefrom. Each of the plurality of terminals extends through one of the plurality of openings. A method of making the battery cell is also disclosed.

### CROSS-REFERENCE TO RELATED APPLICATION

U.S. patent application Ser. No. 11/532,082, filed on Sep. 14, 2006, and owned by the assignee of the present invention, is incorporated herein by reference in its entirety.

### FIELD OF INVENTION

The present invention relates to packaging for large, high power lithium ion cells.

### BACKGROUND

Some lithium ion batteries presently employ laminated foil pouches for containing cell electrolyte. A drawback to these batteries is that the seal of the pouch around the battery terminals tends to leak electrolyte, posing a hazard to users. These batteries are also typically low energy batteries, which do not contain a large amount of electrolyte. A high energy battery having the same general design as the low energy batteries includes more electrolyte than a low energy battery, which provides an increased risk of a large electrolyte leak, should a leak occur. Therefore, there exists a need to provide a high energy battery that reduces the risk of electrolyte leaks.

### SUMMARY

Briefly, the present invention provides a large format prismatic battery cell. The battery cell includes a sealed foil pouch having a plurality of openings and a terminal block disposed within the sealed foil pouch. The terminal block has a plurality of terminals extending outwardly therefrom. Each of the plurality of terminals extends through one of the plurality of openings. A method of making the battery cell is also disclosed.

The invention also provides a method of manufacturing a lithium ion battery cell. The method comprises the steps of forming a plurality of foil lamination openings in a flexible foil lamination; engaging a terminal block with the flexible foil lamination, the terminal block having a plurality of terminal openings extending outwardly therefrom; folding the foil laminate over the terminal block such that each of the plurality of terminal openings communicates with one of the plurality of foil lamination openings; sealing two sides of the foil lamination on either side of the terminal block, leaving an open side of the foil laminate disposed away from the terminal block; inserting a cell stack of electrodes through the open side, the stack of electrodes having a plurality of terminals, each of the plurality of terminals extending through a respective one of the terminal openings and foil lamination openings; sealing the open side, forming a pouch; and inserting an electrolyte into the pouch.

The present invention further comprises a battery cell manufactured by the method described above.

The invention also provides a battery cell comprising a flexible foil pouch having a plurality of openings therein and a non-electrically conducting terminal block disposed within the flexible foil pouch, the foil pouch being sealed to the terminal block. A negative terminal extends through the terminal block and through a first of the plurality of openings and a positive terminal extends through the terminal block and through a second of the plurality of openings. A relief valve is coupled to the terminal block and extends through a third of the plurality of openings. A plurality of positive conductor electrodes are disposed within the flexible foil pouch and electrically coupled to the positive terminal and a plurality of negative conductor electrodes are disposed within the flexible foil pouch and electrically coupled to the negative terminal. An electrolyte is disposed within the flexible foil pouch and is in fluid communication with the relief valve. A lid is disposed over the foil pouch. The lid has a plurality of openings, with the positive terminal extending through a first of the lid openings and the negative terminal extending through a second of the lid openings.

### BRIEF DESCRIPTION OF THE DRAWINGS

The foregoing summary, as well as the following detailed description of the invention, will be better understood when read in conjunction with the appended drawing. For the purpose of illustrating the invention, there is shown in the drawings certain embodiments of the present invention. It should be understood, however, that the invention is not limited to the precise arrangements and instrumentalities shown. In the drawings:

FIG. 1 is a perspective view of a large format lithium ion cell according to an exemplary embodiment of the present invention;

FIG. 2 is an exploded perspective view of the cell illustrated in FIG. 1;

FIG. 3 is a front elevational view, in section, of the cell illustrated in FIG. 1;

FIG. 3A is an enlarged view of the top portion of the cell illustrated in FIG. 3;

FIG. 4 is a side elevational view, in section, of the cell illustrated in FIG. 1;

FIG. 5 is a flowchart illustrating an exemplary method of manufacturing the cell of FIGS. 1-4;

FIG. 6 is a top plan view of an exemplary laminate used to make a pouch for the cell of FIGS. 1-4;

FIG. 7 is a top plan view of a terminal block engaged with the laminate of FIG. 6;

FIG. 8 is a side elevational view of the laminate of FIG. 7 folded over the terminal block and partially sealed to form a pouch; and

FIG. 9 is a side elevational view of a stack of electrodes being inserted into the pouch of FIG. 8.

### DETAILED DESCRIPTION OF THE INVENTION

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale.

The following describes particular embodiments of the present invention. It should be understood, however, that the invention is not limited to the embodiments detailed herein. Generally, the following disclosure refers to a package for high power lithium ion cells, although the inventive package may be used for other types of cells.

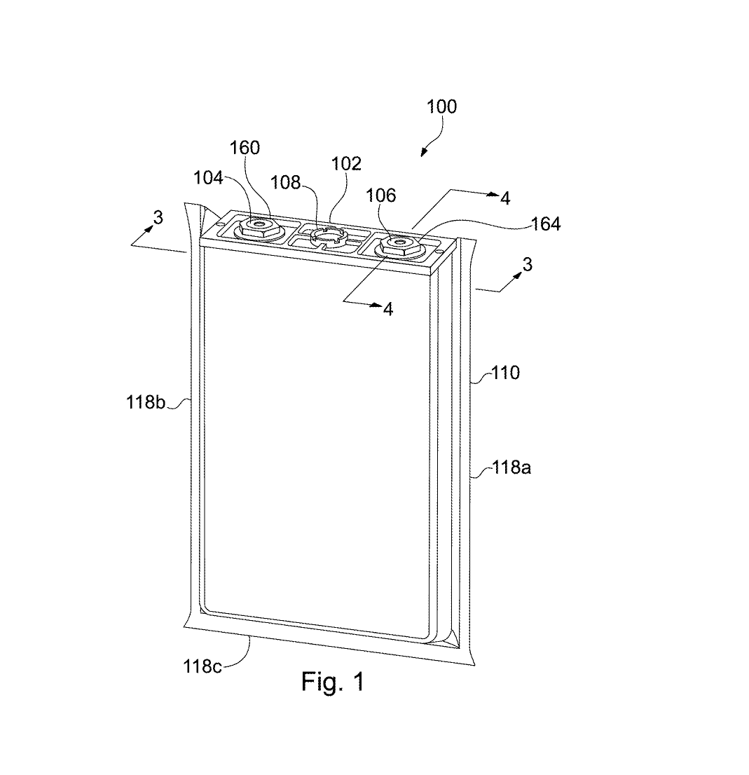

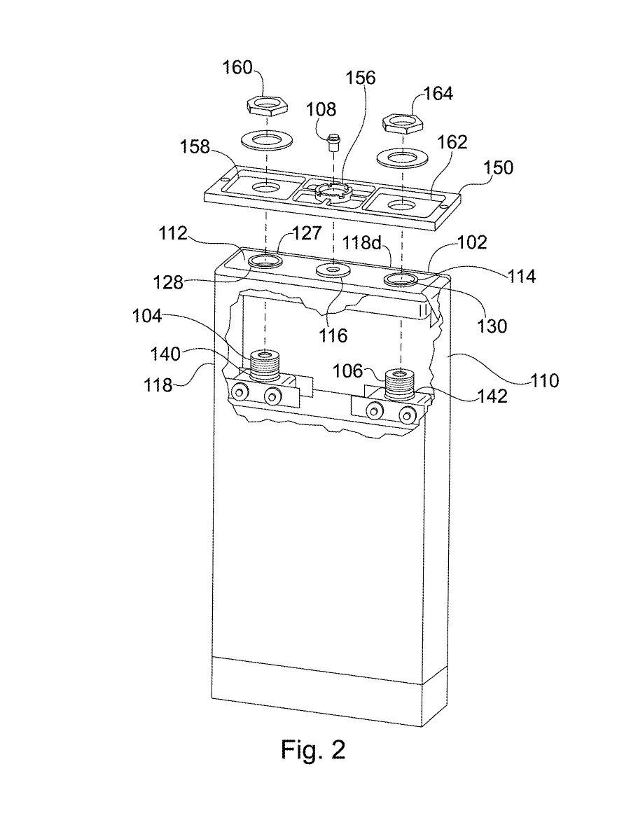

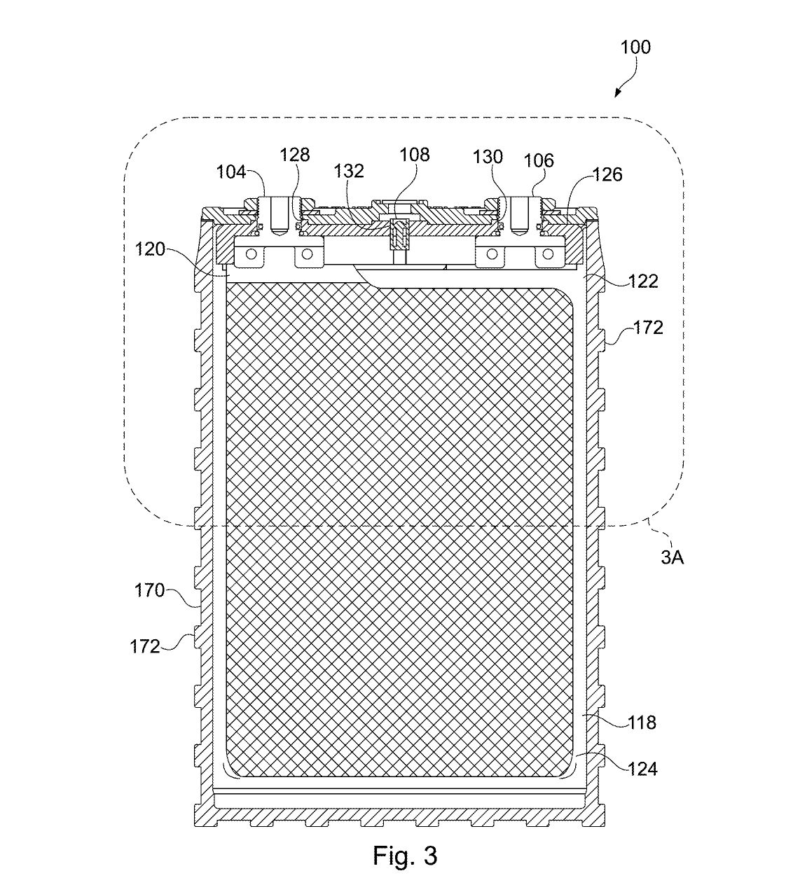

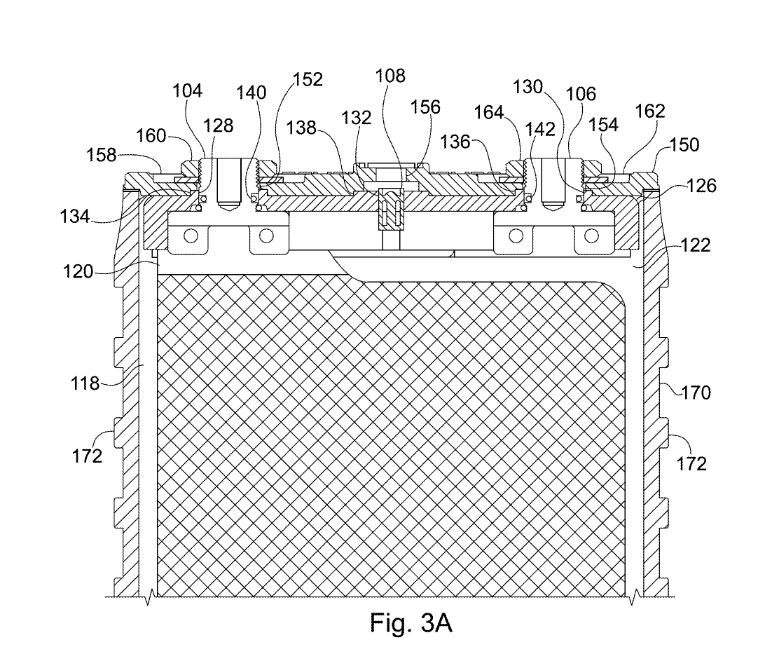

In an exemplary embodiment illustrated in FIGS. 1-4, a large format prismatic battery cell, or cell, 100 according to the present invention may be large enough to transmit up to about 100 amps of current. Cell 100 has a generally parallelepiped shape, with a generally flat top portion 102 that includes a positive terminal 104, a negative terminal 106, and a dynamically self-sealing, multi-operational, spring-loaded relief valve 108 that releases excess gas pressure that may build up inside cell 100. Relief valve 108 may be a model 122 pressure relief valve provided by Smart Product, Inc. of Morgan Hill, Calif.

Cell 100 includes a hermetically, sealed foil lamination 110 having a plurality of openings 112, 114, 116 at top portion 102. Laminate 110 forms a pouch 118 that retains a plurality of positive electrodes 120, a plurality of negative electrodes 122, and an electrolyte 124 that allows ionic conductivity between positive electrodes 120 and negative electrodes 122. In this example, electrolyte 124 is an organic electrolyte. In other embodiments, electrolyte 124 may be any other suitable composition. Pouch 118 is hermetically sealed to prevent electrolyte 124 from leaking out of pouch 118.

Foil lamination 110 forms pouch 118 by sealing foil lamination 110 around three sides—longitudinal sides 118a, 118b, and at bottom 118c. A top portion 118d of foil lamination 110 along top portion 102 of cell 100 is continuous laminate, with the exception of openings 112, 114, 116, with no seals sealing sides of laminate 110 to each other.

Positive terminal 104 is electrically coupled to positive electrode electrodes 120 and negative terminal 106 is electrically coupled to negative electrodes 122 such that electrical current generated between electrodes 120, 122 is transmitted through terminals 104, 106 to power a device (not shown) that is electrically coupled to cell 100.

A terminal block 126 is disposed within pouch 118. Terminal block 126 may be fabricated from polypropylene or some other suitable electrically insulating or non-conductive material. Terminal block 126 has a generally flat top surface 127 with a plurality of terminal openings 128, 130, 132 extending therethrough. Terminal openings 128, 130, 132 are spaced to provide a location for positive terminal 104 and negative terminal 106 of cell 100 and maintain a consistent center-to-center distance between positive terminal 104 and negative terminal 106. Terminal block 126 has rounded edges that reduce the likelihood of foil 110 being torn or otherwise pierced by terminal block 126. Terminal block 124 supports pouch 118 after cell 100 has been assembled.

Each of terminal openings 128, 130, 132 is reinforced with a peripheral flange 134, 136, 138, respectively, that extends outwardly from terminal block 126. Positive terminal 104 extends through terminal opening 128 and negative terminal 106 extends through terminal opening 130. Relief valve 108 is disposed in terminal opening 132. Flanges 134, 136, 138 provide mechanical support for positive terminal 104, negative terminal 106, and relief valve 108. Flanges 134, 136, 138 also separate foil 110 from respective openings 128, 130, 132.

Flange 134 extends through opening 112 in foil 110, flange 136 extends through opening 114 in foil 110, and flange 138 extends through opening 138. Foil 110 is thermally sealed to flat surface 127 of terminal block 126 around flanges 134, 136, 138.

An o-ring 140 is disposed around positive terminal 104 and seals a gap between positive terminal 104 and terminal block 126 such that positive terminal 104 is sealed against terminal block 126. Similarly, an o-ring 142 is disposed around negative terminal 106 and seals a gap between negative terminal 106 and terminal block 126 such that negative terminal 106 is also sealed against terminal block 126.

A lid 150 is disposed over flat top portion 102 of cell 100. Lid 150 includes a first lid opening 152 through which positive terminal 104 extends, a second lid opening 154 through which negative terminal 106 extends, and a third lid opening 156 through which relief valve 108 discharges.

Lid 150 includes a first recess 158 generally surrounding first lid opening 152 that provides a seat for a first retaining nut 160 that is threaded over positive terminal 104. Lid 150 also includes a second recess 162 generally surrounding second lid opening 154 that provides a seat for a second retaining nut 164 that is threaded over negative terminal 106. Retaining nuts 160, 164 also serve to retain lid 150 onto cell 100. Lid 150 may be fabricated from polypropylene or any other electrically insulating polymer material. Lid 150 provides mechanical support for cell 100 and provides spacing consistency between adjacent cells 100.

A case 170 is closed on five sides and is open at the top to allow pouch 118 to be inserted therein. After pouch 118 is inserted into case 170, lid 150 is secured over the top of case 170 via a variety of methods including thermal sealing, ultrasonic welding, adhesive bonding, mechanical snap fitment, or screws. Case 170 includes a plurality of ribs 172 extending around the outer perimeter thereof to provide structural support.

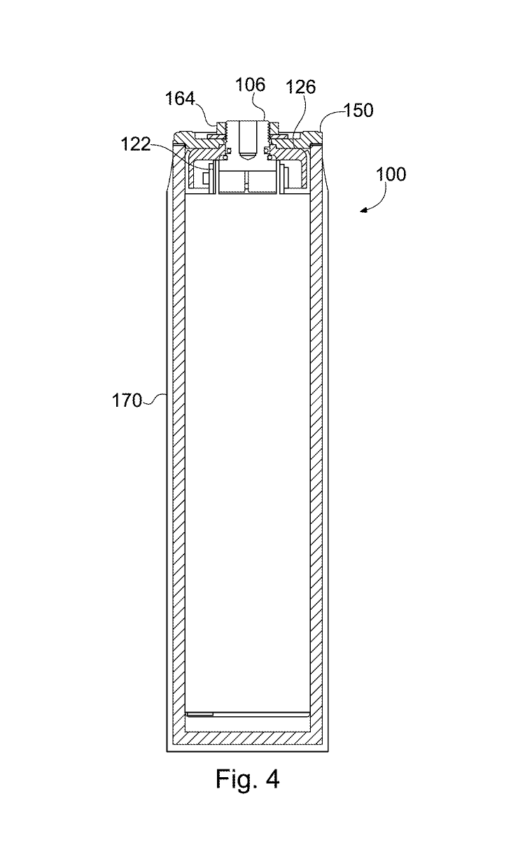

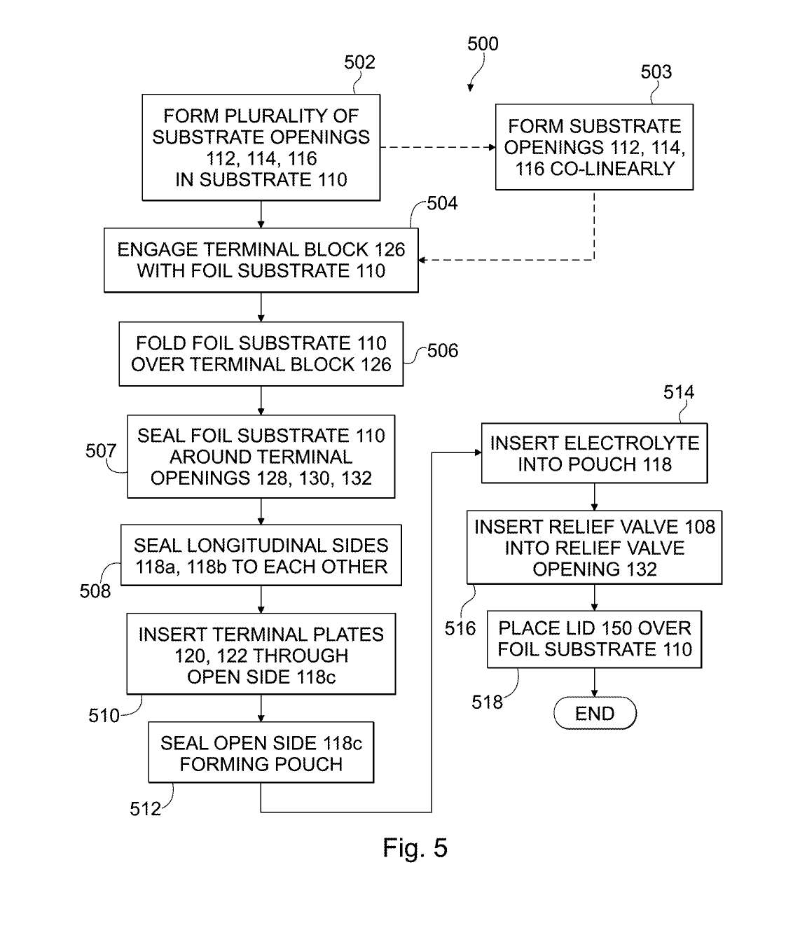

Referring to flowchart 500 in FIG. 5 and FIGS. 6 - 9, an exemplary method of manufacturing cell 100 shown in FIG. 6 comprises step 502 of forming the plurality of laminate openings 112, 114, 116 in foil laminate 110. Optionally, in step 503, the plurality of laminate openings 112, 114, 116 may be formed co-linearly.

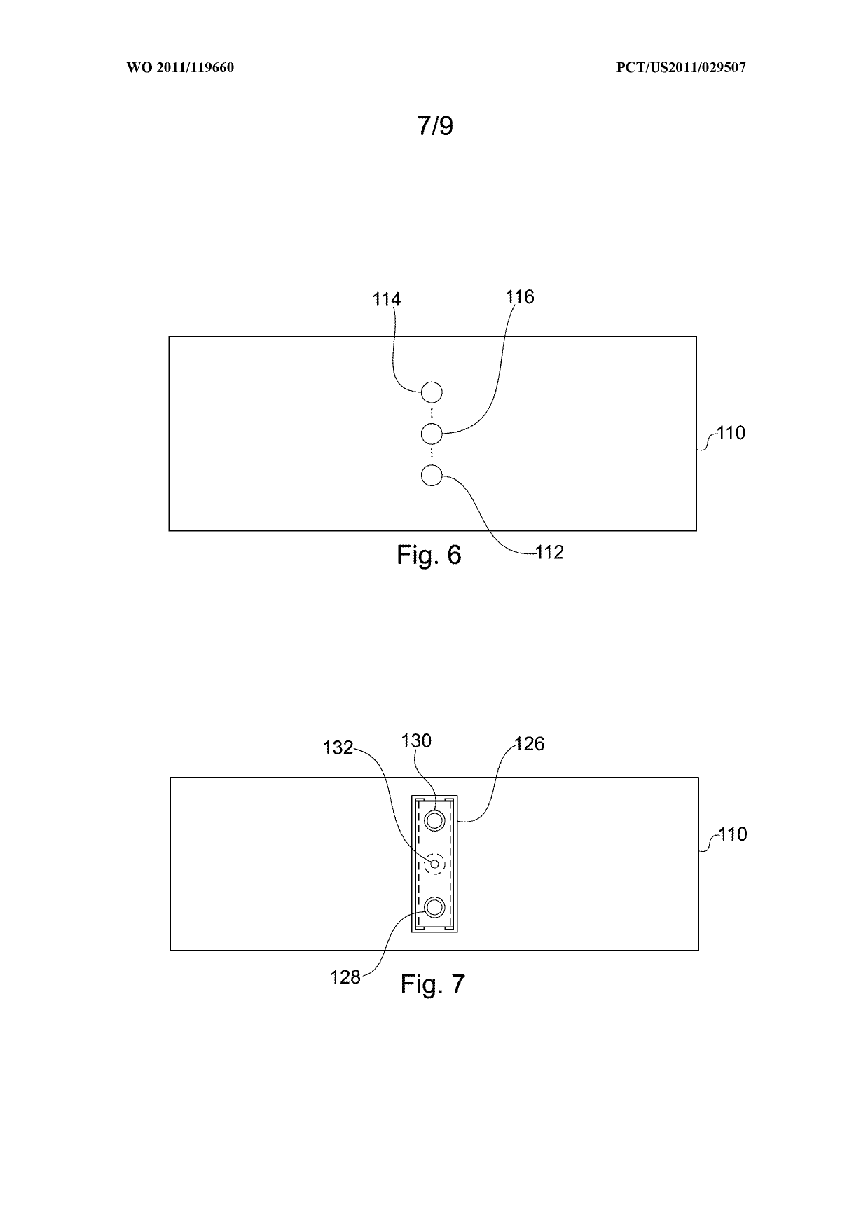

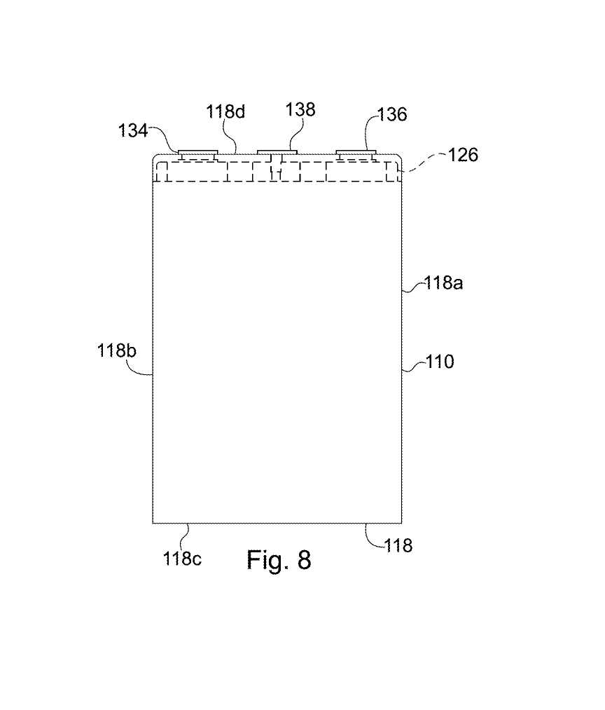

In step 504, and as illustrated in FIG. 7, terminal block 126 is engaged with foil laminate 110. In step 506, foil laminate 110 is folded over terminal block 126 such that each of the plurality of terminal openings 128, 130, 132 communicates with a respective one of the plurality of laminate openings 112, 114, 116. In step 507, and as illustrated in FIG. 8, foil laminate 110 is heat sealed around each of the plurality of terminal flanges 134, 136, 138. In step 508, two longitudinal sides 118a, 118b of foil laminate 110 are sealed to each other on either side of terminal block 126, leaving an open side 118c of foil laminate 110 disposed away from terminal block 126.

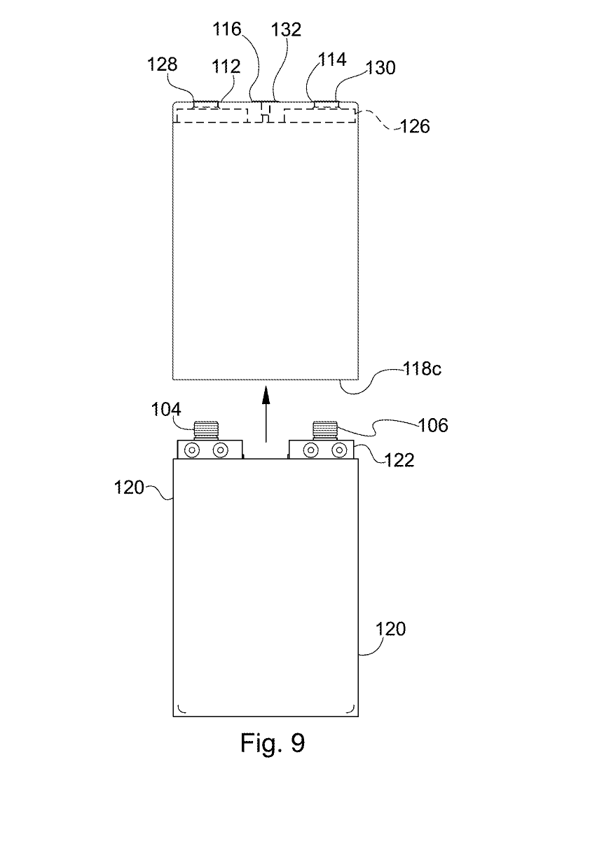

In step 510, and as illustrated in FIG. 9, terminal electrodes 120, 122 are inserted through the open side 118c such that each of the plurality of terminals 104, 106 extends from terminal block 126 through a respective one of the terminal openings 128, 130 and laminate openings 112, 114 (shown in FIG. 1). In step 512, open side 118c is sealed, forming pouch 112. In step 514, electrolyte 124 is inserted into pouch 112 through relief valve opening 132 and laminate opening 116. Electrolyte 124 may be inserted into pouch 112 in accordance with the disclosure in U.S. patent application Ser. No. 11/532,082. After electrolyte 124 is inserted into pouch 112, in step 516, relief valve 108 is inserted into relief valve opening 132. In step 518, lid 150 is disposed on foil laminate 110 such that each of the plurality of terminals 104, 106 extends through lid 150.

While the principles of the invention have been described above in connection with preferred embodiments, it is to be clearly understood that this description is made only by way of example and not as a limitation of the scope of the invention.

What is claimed is:

1. A battery cell comprising:
a sealed foil pouch having a plurality of openings;
a terminal block disposed within the sealed foil pouch, the terminal block having a plurality of terminals extending outwardly therefrom, each of the plurality of terminals extending through one of the plurality of openings.

2. The battery cell according to claim 1, further comprising a relief valve extending through one of the plurality of openings.

3. The battery cell according to claim 1, further comprising a seal sealingly coupling the terminal block to the foil pouch around each of the plurality of openings.

4. The battery cell according to claim 1, wherein the terminal block is fabricated from an electrically non-conductive material.

5. The battery cell according to claim 1, further comprising a seal wherein each of the plurality of terminals is sealed against the terminal block.

6. The battery cell according to claim 1, further comprising a lid disposed over foil pouch, the lid having a plurality of lid openings, each of the plurality of terminals extending through a respective one of the plurality of lid openings.

7. The battery cell according to claim 1, wherein the foil pouch is sealed to itself along three sides.

8. The battery cell according to claim 7, wherein the foil pouch is sealed to the terminal block.

9. The battery cell according to claim 7, wherein the foil pouch is a continuous laminate along a top of the terminal block.

10. A method of manufacturing a battery cell comprising the steps of:
a) forming a plurality of foil laminate openings in a foil laminate;
b) engaging a terminal block with the foil laminate, the terminal block having a plurality of terminal openings formed therein;
c) folding the foil laminate over the terminal block such that each of the plurality of terminal openings communicates with one of the plurality of foil laminate openings;
d) sealing two sides of the foil laminate on either side of the terminal block, leaving an open side of the foil laminate disposed away from the terminal block;
e) inserting a stack of terminal electrodes through the open side, the stack of terminal electrodes having a plurality of terminals, each of the plurality of terminals extending through a respective one of the terminal openings and foil laminate openings;
f) sealing the open side, forming a pouch; and
g) inserting an electrolyte into the pouch.

11. The method according to claim 10, wherein step g) comprises inserting the electrolyte through one of the plurality of foil laminate openings.

12. The method according to claim 11, further comprising, after step g), the step of inserting a relief valve into the one of the plurality of foil laminate openings.

13. The method according to claim 10, wherein step a) comprises forming the plurality of foil laminate openings co-linearly.

14. The method according to claim 10, wherein step c) comprises the step of sealing the foil laminate around each of the plurality of terminals.

15. The method according to claim 10, further comprising the step of disposing a lid on the foil laminate such that each of the plurality of terminals extends through the lid.

16. A battery cell manufactured by the method of:
a) forming a plurality of foil laminate openings in a foil laminate;
b) engaging a terminal block with the foil laminate, the terminal block having a plurality of terminal openings formed therein;
c) folding the foil laminate over the terminal block such that each of the plurality of terminal openings communicates with one of the plurality of foil laminate openings;
d) sealing two sides of the foil laminate on either side of the terminal block, leaving an open side of the foil laminate disposed away from the terminal block;
e) inserting a stack of terminal electrodes through the open side, the stack of terminal electrodes having a plurality of terminals, each of the plurality of terminals extending through a respective one of the terminal openings and foil laminate openings;
f) sealing the open side, forming a pouch; and
g) inserting an electrolyte into the pouch.

17. The battery cell according to claim 16, wherein step g) is performed by inserting the electrolyte through one of the plurality of foil laminate openings.

18. The battery cell according to claim 17, further comprising, after step g), the step of inserting a relief valve into the one of the plurality of foil laminate openings.
